(19) United States
(12) Patent Application Publication
(10) Pub. No.: US 2006/0145382 A1
(43) Pub. Date: Jul. 6, 2006

(54) Method for manufacturing three-dimensional active carbon fabric structure

(75) Inventors: Po-Hsiung Huang, Taipei City (TW); Chao-Chun Peng, Hsinchu City (TW)

Correspondence Address: FISH & RICHARDSON PC, P.O. BOX 1022, MINNEAPOLIS, MN, 55440-1022, US

(73) Assignee: TAIWAN TEXTILE RESEARCH INSTITUTE

(21) Appl. No.: 11/099,116

(22) Filed: Apr. 5, 2005

(30) Foreign Application Priority Data
Jan. 5, 2005 (TW) 94100288

(51) Int. Cl. C04B 40/00

(52) U.S. Cl. 264/82

(57) ABSTRACT

A method for forming a three-dimensional carbonizable fabric structure is provided. The fabric structure may be treated by a thermal treatment through a continuous thermal system including agent impregnation, oxidation, carbonization, and activation processes. In one embodiment the three-dimensional fabric structures are transferred through a thermal system by a tension-roller apparatus. The processing parameters includes processing temperature; processing time; addition of nitrogen, oxygen, and steam; and transferring speed, may be adjusted in accordance with the desired specific surface area, the pore size distribution, and the unit weight of the fabric structure.

### RELATED APPLICATIONS

The present application is based on, and claims priority from, Taiwan Application Serial Number 94100288, filed Jan. 5, 2005, the disclosure of which is hereby incorporated by reference herein in its entirety.

### FIELD OF THE INVENTION

The present invention relates to a three-dimensional active-carbon fabric structure and a manufacturing process thereof, and more particularly, to the three-dimensional active-carbon fabric structure that can remove toxin and adsorb odor.

### BACKGROUND OF THE INVENTION

Active carbon, such as granular carbon, powdery carbon, pulverized carbon, etc., has been widely utilized in gaseous or liquid fluid for removing impurities, and adsorbing toxic materials and bad smells. The aforementioned gas or liquid fluid generally contains materials of various molecular weights. However, the conventional active carbon merely has micro-pores of small diameters, and thus fails to adsorb the material whose molecular weight is more than about 500 Daltons (D). In order to solve the problems described above, active carbon fibers of various pore diameters are further developed. For example, U.S. Pat. No. 4,696,742 provides active carbon fibers that are capable of removing the compounds of various molecular weight ranges existing in an aqueous liquid.

Nevertheless, the active carbon fibers have the shortcoming of limited service life. When the micro-pores of the active carbon fibers are saturated with the adsorbed molecules, the active carbon fibers lose the capability of adsorption. In order to tackle the problem, various processes were provided for enhancing the adsorptive ability and prolonging the service life for active carbon fibers. For example, U.S. Pat. No. 6,319,440 utilizes an oxidizing treatment to bond cupric ion to a carrier H₂S that is located on active carbon fiber, thereby providing a deodorant material having a longer service life. U.S. Pat. No. 4,772,455 utilizes an alkali treatment to enhance the adsorptive ability of an active carbon fiber, thereby providing a meshed active carbon fiber structure for adsorbing hazard gas. U.S. Pat. No. 5,238,899 discloses a deodorizing material having a deodorizing functional group fixed to a graphitic six-membered ring on the surface of the active carbon. However, the active carbon fibers disclosed in U.S. Pat. Nos. 6,319,440, 4,772,455 and 5,238,899, all have to be undergone several chemical treatments, and the reagents used in those chemical treatments all cause the problems of lowering the adsorb ability of the active carbon fibers due to the blockade of the micro-pores thereof.

Furthermore, in order to obtain the efficiency of adsorption, the meshed active carbon fibers generally need to be stacked repeatedly on a substrate so as to enhance the tensile strength. However, the liquid and gas flow may be obstructed by the active carbon fibers stacked on the substrates, thus causing a pressure drop during operation. To resolve this problem, various three-dimensional fabric substrates are provided. A three-dimensional fabric substrate can increase the reaction surface area, and reduce the pressure drop caused by the stacked active carbon fibers. In addition, the tree-dimensional fabric substrates can enhance the operational strength of absorption structure, and various methods can be used therein to fix the active carbon on/in the three-dimensional fabric substrate. For example, FIG. 1 illustrates an optical microscopic image showing that a polypropylene substrate is melt-blown with granular active carbon, according to a conventional skill, and in FIG. 2 shows that granular active carbon powder is adhered to a fabric substrate with different kinds of binders. However, the conventional skills often have the problems of some active carbon powder falling off the fabric substrate, thus generating another pollution source and also, the use of binders could cause the reduction of absorption (at least 20% ) due to the blockade of the pores of the active carbon.

In order to resolve the problem described above, a method for producing a flame resistant fabric is provided. A flame resistant fiber many be produced from a bundle of carbonizable fiber treated by a flame resistance process with in air ambiance of 200° C. to 300° C. Then flame resistance fiber can be woven to produce a three-dimensional fabric. Subsequently, the three-dimensional fabric is treated by an activation process with in an active gases ambiance of 700° C. to 1,000° C. to obtain the flame resistant fabric.

However there are still several drawbacks of the flame resistant fabric, such as complicated process, high manufacturing cost, and with deficient tensile for operating.

It is desirable, therefore, to provide a three-dimensional fabric structure having high adsorptive ability, long service life, high tensile strength, low pressure-drop and simple manufacture process without complicated chemical treatments.

### SUMMARY OF THE INVENTION

Active carbon, such as granular active carbon, powdery active carbon, pulverized active carbon, an active carbon fiber, etc., has been widely utilized in the treatment of liquid and gaseous fluid, hazard chemical recycling, and medical purpose for removing impurities and adsorbing toxic materials and odors. According to the aforementioned purposes, the ways for applying active carbon all are to fix active carbon on a substrate, and then introduce the liquid or gas to be treated to flow through the substrate, thereby achieving the purposes of treatment. However, the aforementioned treatment ways easily cause operational pressure drop due to the resistance from the substrate and the active carbon, thus resulting in energy waste and inefficiency.

Therefore, the object of the present invention is to provide a three-dimensional carbon fabric structure having high adsorptive ability, long service life, high tensile strength, low operational pressure drop, and a simple manufacturing process.

At first, a regular or irregular three-dimensional fabric structure is fabricated, and preferably, the three-dimensional structure is a regular structure, and more preferably, a three-dimensional structure similar to a honeycomb. The three-dimensional structure includes two planes and each of which is interlaced with longitudinal fibers and latitudinal fibers, and connecting fibers interconnected between the two planes. In a preferable embodiment of present invention, the three-dimensional structure may have a cross section like a sandwich, i.e. the two planes are connected by some vertical fibers interlaced with each other regularly or irregularly.

Then, the three-dimensional fabric structure may be treated by a thermal treatment through a continuous thermal system including agent impregnation, oxidation, carbonization, and activation processes. In an embodiment of present invention, the three-dimensional fabric structure is transferred through a thermal system by means of a tension-roller apparatus, wherein the tension-roller apparatus can be used to control the transfer speed of the three-dimensional fabric structure through the tunnel and the tension resistance of thereof during the thermal treatment. The oxidation, carbonization, and activation processes may be performed in different areas of the thermal system in which a gas mixture of oxygen, nitrogen and steam may be injected. The processing parameters including process temperature, process duration, gas injection amount, and transferring speed of the three-dimensional structure may be adjusted in accordance with the desire properties of the final product of the present invention. The desire properties include specific surface area, pore size distribution of active carbon, and the unit weight of the product.

The three-dimensional active carbon fabric structure of the present invention has superior adsorptive ability and longer validity term, and can effectively reduce pressure drop without lowering adsorbing efficiency. Besides no need to add alkaline or other chemicals, the three-dimensional active carbon fabric structure of the present invention has more tensile strength, adsorption capacity, and less pressure drop than the conventional ones.

### BRIEF DESCRIPTION OF THE DRAWINGS

The forgoing aspects and many of the attendant advantages of this invention will become more readily appreciated as the same becomes better understood by reference to the following detailed description, when taken in conjunction with the accompanying drawing, wherein:

FIG. 1 illustrates an optical microscopic profile showing that a polypropylene substrate is melt-blown with granular active carbon according to the prior art;

FIG. 2 illustrates an electron microscopic profile showing that some granular active carbon is adhered to a fabric substrate by some kind of binders according to the prior art;

FIG. 3 illustrates a honeycombed like structure with reference to a preferable embodiment of present invention;

FIG. 4 illustrates the thermal system with reference to a preferable embodiment of present invention wherein the oxidation, carbonization, and activation are conducted continually, and a dynamic diagram is provided showing the thermal dynamic situation;

FIG. 5 illustrates the electron microscopic profiles showing the different appearances of the pores forming on the three-dimension fabric structures;

FIG. 6 illustrates the duplication of total pore volume analyses in an isotherm situation with reference to a preferable embodiment of present invention;

FIG. 7 illustrates the duplication of pore size distribution calculated from the t-method with reference to a preferable embodiment of present invention;

FIG. 8 illustrates the results of an absorption test according to American Society Test and Material (ASTM) standard D3467-94, with reference to a preferable embodiment of present invention.

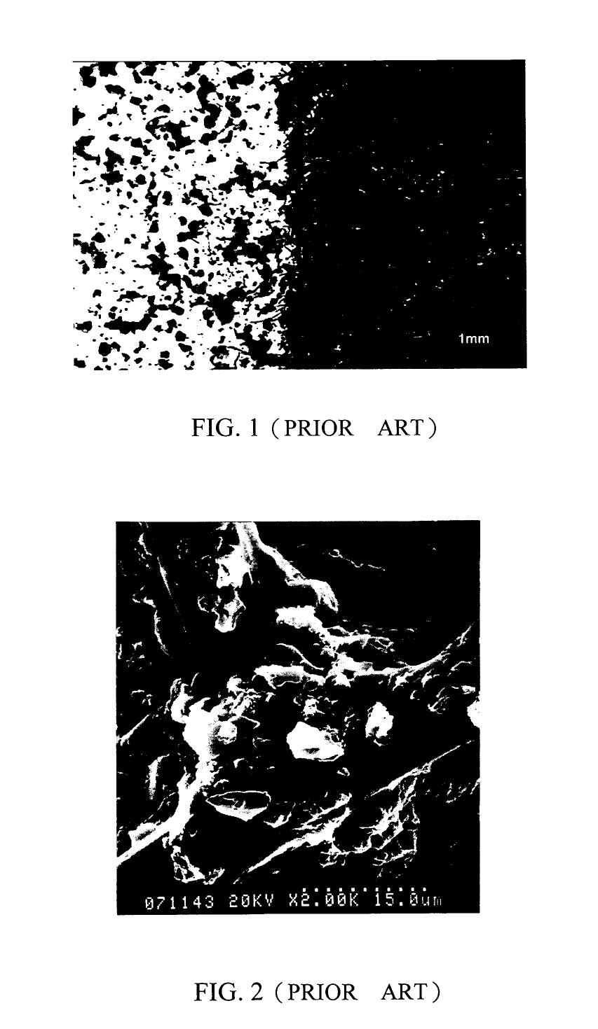

### DETAILED DESCRIPTION OF THE PREFERRED EMBODIMENT

The active carbon fabric structure and many of the attendant advantages of this invention will become more readily appreciated, as the same becomes better understood by reference to the following detailed description of some preferable embodiments.

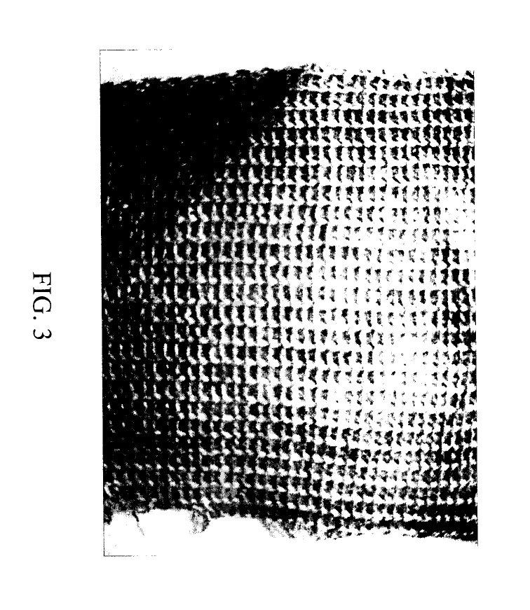

According to present invention, the fabric structure is a three-dimensional fabric structure. The three-dimensional fabric structure is fabricated in various types of tubular design, transfer design, and /or tuck design. The three-dimensional fabric structure may be made from several kinds of carbonizable materials. In some embodiments of present invention, these carbonizable materials may be phenolic materials, polyacrylonitrile, rayon or cellulose or the combination thereof. The three-dimensional fabric structure may be a regular or an irregular structure, but preferable a regular structure, and more prefer a honeycombed like structure. In a preferable embodiment, the three-dimensional fabric structure has a cross-section, like a sandwich. FIG. 3 illustrates a three-dimensional fabric structure similar to a honeycomb with reference to a preferable embodiment of present invention. In the embodiment, the three-dimensional fabric structure is with a thickness of 2 mm and above and with a unit weight ranging about 200 g˜500 g per m². Furthermore, the three-dimensional fabric structure has a (Langmuir) specific surface area which is greater than 2682 m²/g; and has a strength which is greater than 25 kg/50 mm.

Consequently, the three-dimensional fabric structure is immersed in animpregnate agent. The impregnate agent comprises ammonium sulphate ((NH₄)₂SO₄) and ammonium hydrogen phosphate ((NH₄)₂HPO₄). In a preferable embodiment, the ratio of ammonium sulphate to ammonium hydrogen phosphate is 85:15.

A continual thermal treatment including an oxidation process, a carbonization process and an activation process may be conducted on the immersed three-dimensional fabric structure within a thermal system.

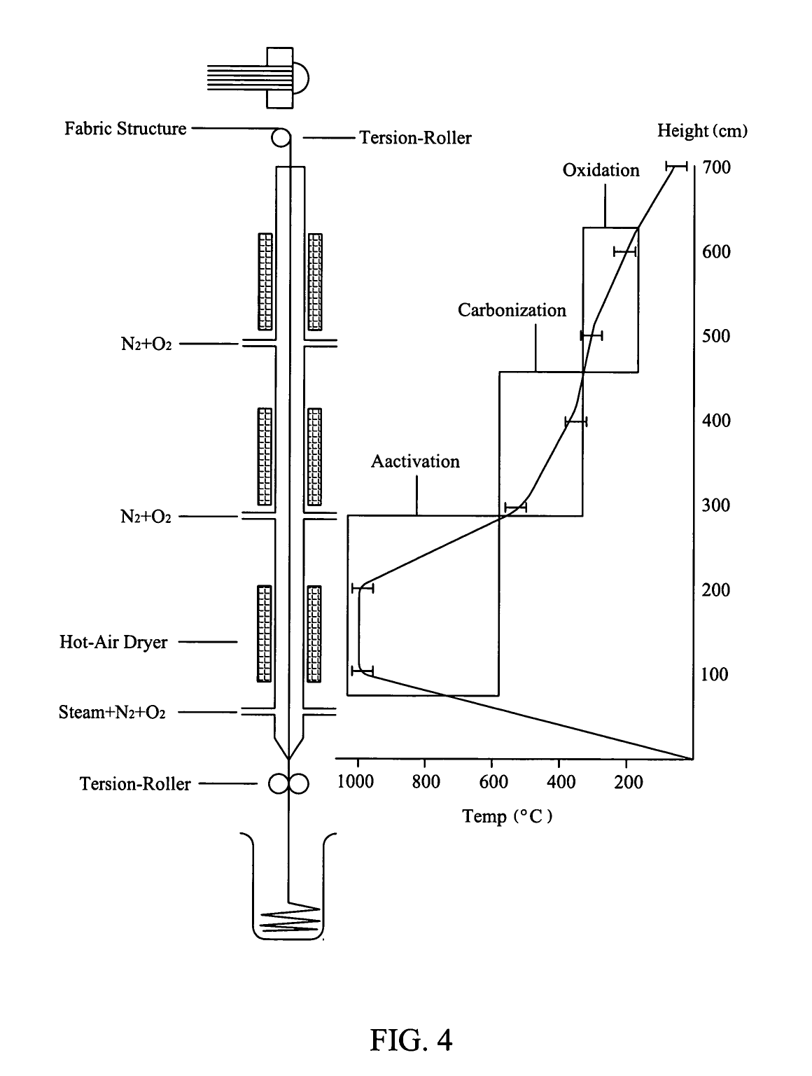

FIG. 4 illustrates a thermal system and it is corresponding to the thermal dynamic curve according to a preferable embodiment of present invention. The immersed three-dimensional fabric structures are transferred through a thermal tunnel by several tension-roller apparatuses. In this preferable embodiment, the transfer speed is maintained in 15 cm/min and the processing tension of the three-dimensional fabric structures may be kept in 15 kg. Both of the transferring speed and the processing tension may be controlled by the tension-roller apparatuses which are located on both the entry and the outlet of the thermal system.

In the thermal system, oxygen, nitrogen, and steam are infused within the tunnel by the means of gas infusion for controlling the forming of the pores. In a preferable embodiment, the mixture of oxygen and nitrogen may be added in at an infusion rate of 1 L/min during the oxidation process and carbonization process, and the mixture of oxygen, nitrogen and steam may be added in at an infusion rate of 60 ml/min during the activation process.

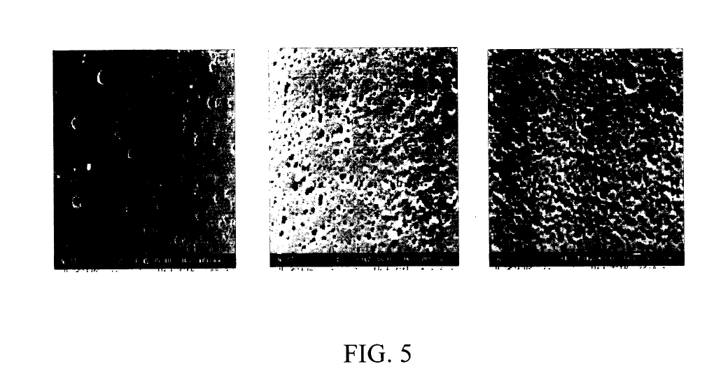

A lot of micro-pores appear on/in the three-dimensional fabric structures during the thermal treatment. The electron microscopy is used to observe the profiles of micro-pores on the surface and it's cross-section of the three-dimensional fabric structures. FIG. 5 illustrates the different appearances of the pores forming on the three-dimensional fabric structures.

The processing duration and processing temperatures are the important factors for forming the pores. Hot air of the thermal system is directed by hot-air dryer apparatus to control the processing temperatures on different processes of the thermal treatment. For example, in the preferable embodiment, during oxidation process, the temperature is controlled about from 70° C. to 330° C.; during carbonization process, the temperature is controlled about from 330° C. to 580° C.; during activation process and the temperature is controlled about from 580° C. to 1,000° C. respectively. It must be noted that the duration of activation process may affect the pore size, if exceeding the suitable rang, the micro-pores could be enlarged as meso-pores even macro-pores, such that could affect the absorption ability of the three-dimensional fabric structures. Therefore, the transfer speed is controlled to adjust the process duration of the thermal treatment. In some alternative embodiments the duration of activation process may be about 15 minutes to 25 minutes.

It must be appreciated, however, the three-dimensional fabric structure can be fabricated by different kinds of materials. Each of them requires different thermal treatment parameters by which to achieve the desired properties of the three-dimensional active carbon fabric structure, such as tension, specific surface area and unit weight. In addition, the properties of the three-dimensional active carbon fabric structure may be altered depend on the ways for applying purposes. Any skilled in the art could achieve the same results of present invention by modifying the parameters of the thermal system. Therefore any change or modify of the thermal system parameters and any suitable thermal system used for thermal treatment may include in the spirit of present invention.

In order to approve the three-dimensional active carbon fabric structure of present invention having the properties of high adsorptive ability, long service life, and low pressure-drop, there were several tests and analyses conducted, such as specific surface area (Langmuir) analysis, pores size distribution analysis, and chloroform absorption test to evaluate the adsorption efficiency comparing with other commercial products.

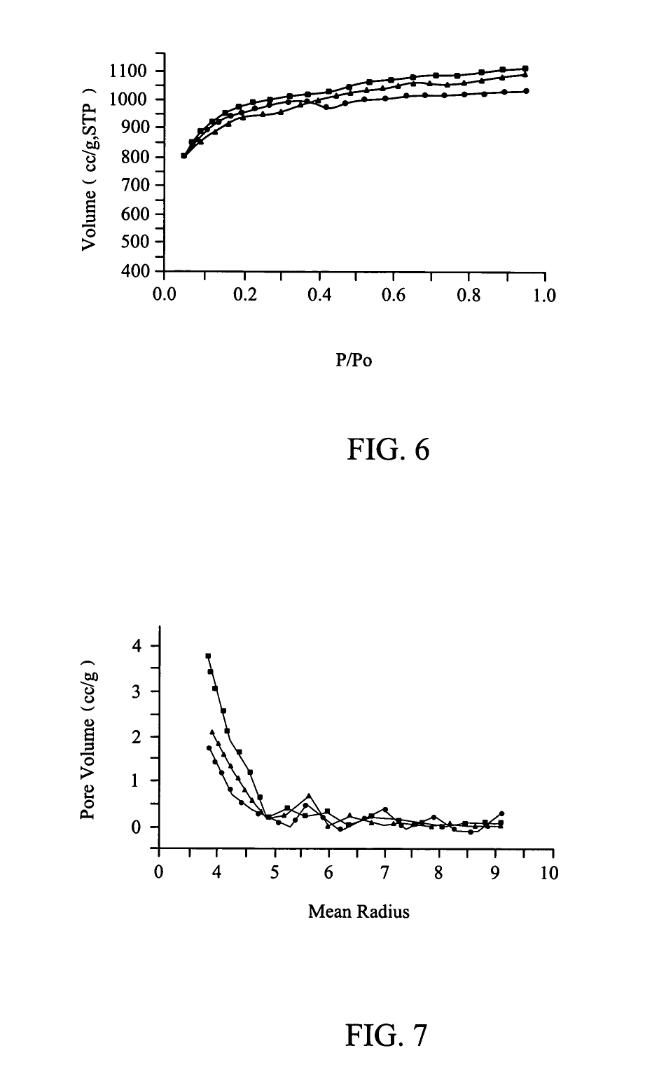

FIG. 6 illustrates the duplicates of total pore volume analyses in an isotherm situation with reference to a preferable embodiment of present invention. Three batches of the three-dimensional active carbon fabric structure are taken to conduct the analysis. In the analysis, nitrogen gas is used to determine the total pore volume of the active carbon in the three-dimensional active carbon fabric structure. FIG. 7 illustrates the results of pore size distribution calculated from the result of FIG. 6 by t-method. The analysis results have been concluded on thereafter

| | Specific | Total Pore | Micro-pore | |
|---|---|---|---|---|
| | surface area | Volume | volume | V mic/V tot |
| | (m²/g) | (cc/g) | (cc/g) | (%) |
| Batch1 | 2682 | 0.9298 | 0.7771 | 83.58 |
| Batch 2 | 2692 | 0.9364 | 0.7772 | 83 |
| Batch 3 | 2694 | 1.0213 | 0.8416 | 82.4 |

According to the table, the ratio of micro pore volume to total pore volume has shown that the three-dimensional active carbon fabric structure of the present invention contains at least 16 percent of meso-pores or macro-pores. It means that the three-dimensional active carbon fabric structure has a wide range of pore size, and has the capability of removing compounds having a wide range of molecular weights existing in an aqueous liquid to be treated.

Thus the mean pore radius can be calculated of 21 ↑1, and the (Langmuir) specific surface area can be determined as greater than 2682 m²/g in average. The three-dimensional active carbon fabric structure has greater specific surface area comparing to the commercial products (with the specific area from about 1700 m²/g to 1800 m²/g ).

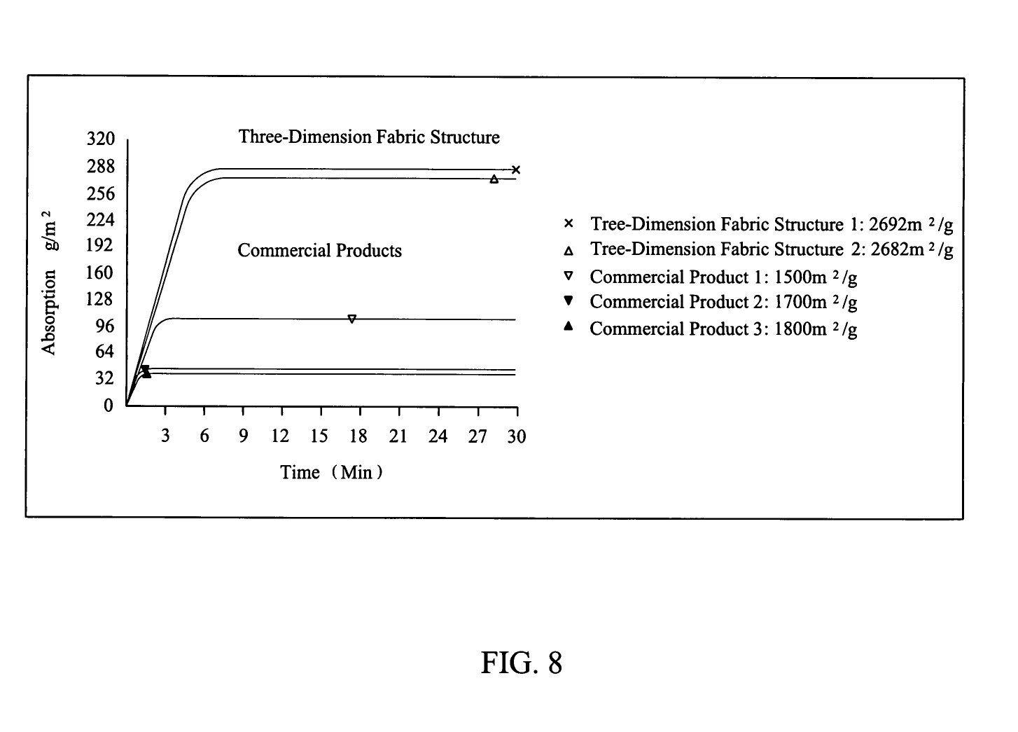

FIG. 8 illustrates the results of an adsorption test according to American Society Test and Material (ASTM ) standard D3467-94. The chloroform is used for adsorption test. From the comparison of absorption curves between the three-dimensional active carbon fabric structure of the present invention and the commercial active carbon textiles used as gauze masks, it is shown that the adsorption efficiency of present invention is about 2.5 times as much as that of the commercial active carbon textiles.

Thereby, it has been proven that the three-dimensional active carbon fabric structure of present invention has higher adsorptive ability and contains a wide range of pore size so as to remove compounds having a wide range of molecular weights existing in an aqueous liquid and gases to be treated.

Additionally, the pressure test is also conducted, and has the results showing that the air permeability is greater than 300 cfm/ft² with a pressure-drop less than 2.5 mmH₂O. Thus, it has been proven that the three-dimensional active carbon fabric structure can reduce the pressure-drop effectively during operation.

As is understood by any skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for forming a three-dimensional active carbon fabric structure, comprising:
providing a carbonizable fiber material;
fabricating the carbonizable fiber material into a three-dimensional fabric structure; and
performing an in-situ continuous thermal treatment onto the impregnated three-dimensional fabric structure in a thermal system.

2. The method for forming a three-dimensional active carbon fabric structure according to claim 1, wherein the carbonizable fiber material is selected from the group consisting of phenolic materials, polyacrylonitrile, rayon, cellulose and the combination thereof.

3. The method for forming a three-dimensional active carbon fabric structure according to claim 1, wherein the three-dimensional structure is with a thickness of 2 mm and above.

4. The method for forming a three-dimensional active carbon fabric structure according to claim 1, further comprising an impregnate process for impregnating the three-dimensional structure.

5. The method for forming a three-dimensional active carbon fabric structure according to claim 4, wherein the impregnate process utilizes a reagent containing Ammonium Sulphate ((NH₄)₂SO₄) and ammonium hydrogen phosphate ((NH4)₂HPO₄)

6. The method for forming a three-dimensional active carbon fabric structure according to claim 1, wherein the thermal system comprises a thermal tunnel, a hot-air drying apparatus, and a gas-infusing apparatus.

7. The method for forming a three-dimensional active carbon fabric structure according to claim 1, wherein the thermal treatment comprises an oxidation process, a carbonization process and an activation process.

8. The method for forming a three-dimensional active carbon fabric structure according to claim 7, wherein the thermal treatment comprises utilizing the hot-air drying apparatus to control the operating temperature ranged essentially from 70° C. to 330° C. during the oxidation process; control the operating temperature ranged essentially from 330° C. to 580° C. during the carbonization process; control the operating temperature ranged essentially from 580° C. to 1,000° C. during the activation process.

9. The method for forming a three-dimensional active carbon fabric structure according to claim 7, wherein the thermal treatment comprises:
injecting a mixture of oxygen and nitrogen at a flow rate of 1 L/min during the oxidation process and the carbonization process; and injecting a mixture of oxygen, nitrogen and steam at a flow rate of 60 ml/min during the activation process.

10. The method for forming a three-dimensional active carbon fabric structure according to claim 1, further comprising a tension-treatment process.

11. The method for forming a three-dimensional active carbon fabric structure according to claim 10, wherein the tension-treatment process utilizes at least one tension-roller apparatus for transferring the three-dimensional structure through the thermal system, and controlling the transfer speed and the tension of the three-dimensional structure.

12. The method for forming a three-dimensional active carbon fabric structure according to claim 10, wherein the transfer speed is maintained at 15 cm/min

13. The method for forming a three-dimensional active carbon fabric structure according to claim 10, wherein the tension is kept at 15 kg.

14. The method for forming a three-dimensional active carbon fabric structure according to claim 1, wherein the profile of the three-dimensional active carbon fabric structure comprises a three-dimensional structure similar to a honeycomb.

15. The method for forming a three-dimensional active carbon fabric structure according to claim 1, wherein the three-dimensional active carbon fabric structure has a Langmuir specific surface area larger than 1,500 m²/g.

16. The method for forming a three-dimensional active carbon fabric structure according to claim 1, wherein the three-dimensional active carbon fabric structure has a unit weight ranged essentially from 200 g/m² to 500 g/m² and a pressure drop less than 2.5 mmH₂O.
